(19) United States
(12) Patent Application Publication
(10) Pub. No.: US 2011/0029702 A1
(43) Pub. Date: Feb. 3, 2011

(54) METHOD AND APPARATUS PERTAINING TO PORTABLE TRANSACTION-ENABLEMENT PLATFORM-BASED SECURE TRANSACTIONS

(75) Inventors: Matthew G. Pirretti, Huntley, IL (US); Ronald F. Buskey, Sleepy Hollow, IL (US)

Correspondence Address: MOTOROLA, INC.;Penny Tomko, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/510,306

(22) Filed: Jul. 28, 2009

(51) Int. Cl. G06F 13/00

(52) U.S. Cl. 710/100

(57) ABSTRACT

A portable transaction-enablement platform carries out certain actions to improve the protection of sensitive information. This can comprise detecting when a user of the portable transaction-enablement platform prepares to use the portable transaction-enablement platform to facilitate a sensitive transaction and then responding in a corresponding manner. This can comprise, for example, automatically pre-enabling transaction-enablement platform functionality as pertains to the sensitive transaction while also limiting transaction-enablement platform functionality that does not support the sensitive transaction and that poses a risk to the sensitive transaction.

### TECHNICAL FIELD

This invention relates generally to portable transaction-enablement platforms and more particularly to secure transactions as facilitated by use of such platforms.

### BACKGROUND

Portable transaction-enablement platforms of various kinds are known in the art. These increasingly include cellular telephones, wireless personal digital assistants, and so forth. Increasingly, such platforms are intended to serve as the user's primary point of connectivity to a wide variety of services and applications. In turn, the transactions supported by such platforms span a wide and seemingly ever-increasing range of activities. Illustrative examples in these regards include, but are certainly not limited to, accessing and reviewing ordinary personal email, browsing a website of interest, placing a bid in an on-line auction, reviewing a bank account, registering to attend a conference of interest, purchasing a product or service, and so forth.

These various transactions vary widely with respect to their corresponding security requirements and needs. Some transactions, for example, likely require little corresponding security as exposure to other parties will reveal nothing that is not otherwise easily publicly available. Other transactions, however, have greater security needs. Such transactions typically involve the exposure or transmission of information that is not otherwise easily publicly available. The need for security in such cases typically increases as the value of the information increases.

As already noted above, end users are increasingly using small portable devices as their point of entry into a wide range of transactions having a correspondingly wide range of security needs or requirements. This application paradigm can easily lead to situations where the end user undertakes a given transaction while using an inappropriate level of security. This can occur, at least in part, because many end users are not sufficiently knowledgeable to independently and consistently make correct decisions in these regards. The small form factor of many portable transaction-enablement platforms contributes to this problem in part because of the limited size of the user interface; for example, security-related content often becomes visually diluted amongst non-security elements of the display.

As a result, as end users increasingly use their small portable devices to engage in a wide variety of transactions, it becomes also increasingly likely that their sensitive transactions will not be accompanied by appropriate security practices. This, in turn, can lead to increased breaches of security involving sensitive and valuable information.

### BRIEF DESCRIPTION OF THE DRAWINGS

The above needs are at least partially met through provision of the method and apparatus pertaining to portable transaction-enablement platform-based secure transactions described in the following detailed description, particularly when studied in conjunction with the drawings, wherein:

FIG. 1 is a flow diagram as configured in accordance with various embodiments of the invention;

FIG. 2 comprises a top plan view as configured in accordance with various embodiments of the invention;

FIG. 3 comprises a top plan view as configured in accordance with various embodiments of the invention;

FIG. 4 comprises a top plan view as configured in accordance with various embodiments of the invention;

FIG. 5 comprises a top plan detail view as configured in accordance with various embodiments of the invention; and

FIG. 6 comprises a block diagram as configured in accordance with various embodiments of the invention.

Skilled artisans will appreciate that elements in the figures are illustrated for simplicity and clarity and have not necessarily been drawn to scale. For example, the dimensions and relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a portable transaction-enablement platform can be configured to carry out certain actions to improve the protection of sensitive information. This can comprise detecting when a user of the portable transaction-enablement platform prepares to use the portable transaction-enablement platform to facilitate a sensitive transaction and then responding in a corresponding manner. This can comprise, for example, automatically pre-enabling transaction-enablement platform functionality as pertains to the sensitive transaction while also limiting transaction-enablement platform functionality that does not support the sensitive transaction and that poses a risk to the sensitive transaction.

By one approach, pre-enabling transaction-enablement platform functionality that pertains to the sensitive transaction can comprise displaying a relative-risk indication. For example, this can comprise calculating a present risk-metric value as a function of a plurality of differing risk-evaluation considerations and presenting the resultant present risk-metric value within a displayed range of risk-metric values.

By one approach, pre-enabling transaction-enablement platform functionality that pertains to the sensitive transaction can comprise automatically modifying a user-input interface to display information regarding at least one item of transaction-enablement platform functionality (such as an item of functionality that is frequently used when facilitating the sensitive transaction). As another example, this can comprise modifying the end-user interface such that the end-user interface now presents information dedicated to facilitating a sensitive transaction in a highly-perceptible form. This can also comprise providing a display background that uniquely signifies facilitating a sensitive transaction.

By one approach, limiting transaction-enablement platform functionality that does not support the sensitive transaction and that poses a risk to the sensitive transaction can comprise suspending operability of at least one element of transaction-enablement platform functionality that does not support the sensitive transaction and that poses a risk to the sensitive transaction. For example, in some cases, this may comprise suspending the operability of an external interface.

So configured, these teachings provide an economical and easily leveraged approach to automatically and dynamically configuring a portable device to both facilitate a sensitive transaction while also automatically configuring the portable device to aid with maintaining the security of that sensitive transaction. These teachings can also be applied to aid in raising the end user's awareness that a sensitive transaction is, in fact, in the offing. Those skilled in the art will appreciate that these teachings are highly scalable and can be usefully applied across a wide range of platforms and application settings.

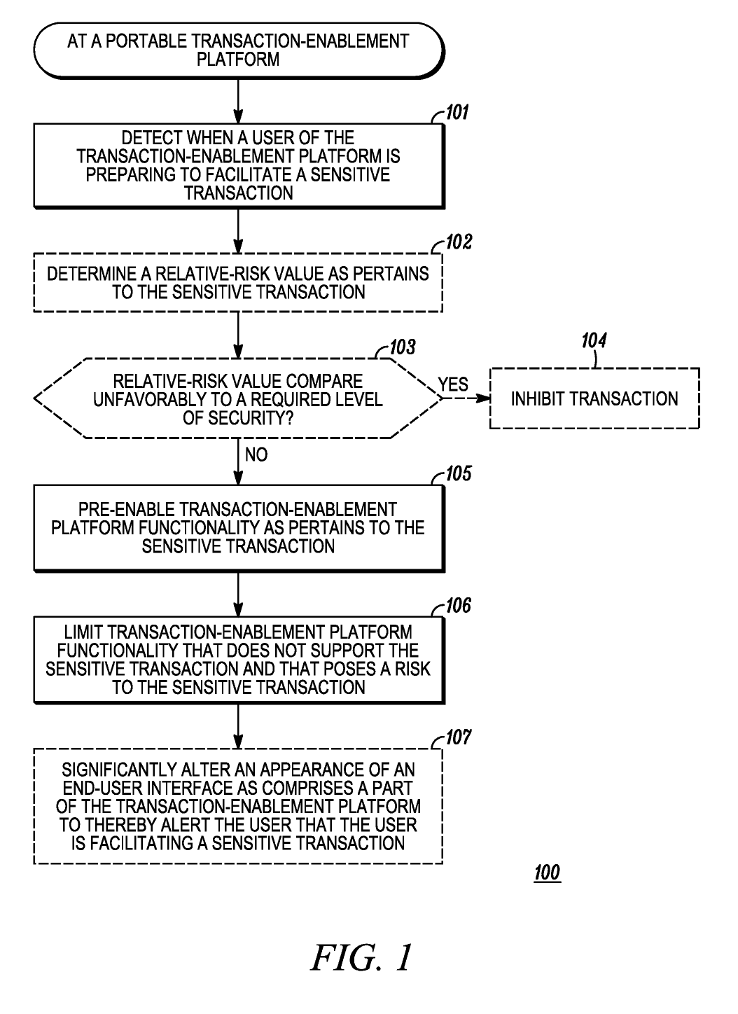

These and other benefits may become clearer upon making a thorough review and study of the following detailed description. Referring now to the drawings, and in particular to FIG. 1, an illustrative process 100 that is compatible with many of these teachings will now be presented. This process 100 can be carried out by, for example, a portable transaction-enablement platform of choice. As used herein, the expression “portable” will be understood to refer to an object having a form factor and weight that is intended to be and is readily carriable by an average adult person in a clothing pocket, woman's purse, so-called fanny pack, holster device, or by hand in the ordinary course of usage. Examples in these regards include, but are not limited to, ordinary and so-called “smart” cellular telephones and personal digital assistants having two-way wireless communication capabilities, or non-laptop work-task devices with general computing and communication capability (such as the hand-held tablets often employed by delivery personnel to track and confirm package deliveries, hand-held inventory tracking and control devices, and so forth). As used herein, the expression “transaction” will be understood to refer to an activity that involves a submission, receipt, or exchange of information.

This process 100 provides the step 101 of detecting when a user of the transaction-enablement platform is preparing to use the transaction-enablement platform to facilitate a sensitive transaction. As used herein, the expression “sensitive transaction” will be understood to refer to a transaction that involves a submission, receipt, or exchange of information that, if learned or otherwise exploited by a third party without authorization or permission, can be directly used to cause personal, financial, or business harm to the user of the transaction-enablement platform. Illustrative examples of such information include, but are certainly not limited to, the user's Personal Identification Number (PIN), the user's Social Security number, the user's credit or debit card account number, Personally Identifiable Information (PII), bank or securities transaction information (including account identification, amounts and balances, authorization information or status, and the like), information regarding pending significant business transactions, and so forth.

This step of detecting when the user is preparing to facilitate a sensitive transaction includes detecting imminent preparation for such an activity. For example, any of the following events can serve as a basis for the detection of imminent preparation of such an activity:

The user selects and clicks a “buy now, “check out now,” or similar button while visiting a website.

Activation of an application whose very nature suggests the presence or exchange of sensitive information (for example, activating a Virtual Private Network (VPN) capability, initiating a secure-voice call, or use of a location-based service).

The user visits a Secure Sockets website (that is, a website having an “HTTPS”-based uniform resource locator).

The user opens a document or file that is password protected, encrypted, or otherwise security tagged.

Initiating a secure service such as a credit card PIN device or a secure-voice function.

Executing a program that is defined by the user or an authorized administrator policy as entailing a sensitive transaction.

On the other hand, this step of detecting when the user is preparing to facilitate a sensitive transaction does not include an indirect, ambiguous indication of such activity. Any of the following illustrative examples would not comprise, in and of themselves, a suitable basis for detecting imminent preparation of such an activity as these events are, at best, indirect ambiguous indicators in this regard:

Merely switching the portable transaction-enablement platform “on.”

Merely directing a browser to the splash page of an ordinary website.

Merely opening a virtual address book.

Merely using a general application such as a music player, a photo viewer, a calculator, a game, or the like.

Those skilled in the art will appreciate that this step 101 does not require receiving from the user a specific, dedicated indication regarding facilitating a sensitive transaction. For example, it is not necessary that the user select and click a button having the sole purpose of indicating the facilitation of a sensitive transaction. Instead, this step 101 contemplates deducing such a state based upon the ordinary usage activities of the user. Accordingly, those skilled in the art will recognize that this step 101 can serve to detect that the user is preparing to use the platform to facilitate a sensitive transaction in a manner transparent to the user.

This process 100 will support the optional step 102 of determining a relative-risk value as pertains to the particular sensitive transaction that is the subject of the detection step 101. Using this approach the process 100 assesses the corresponding risk along some sliding scale instead of merely characterizing the risk as being “present” or “absent.” For example, integer values from one to eight can represent a range of relative risk values. To illustrate, the value “one” can represent a lowest assessed risk while the value “eight” can represent a highest assessed risk. Presuming a linear scale, a value of “three” would represent a modest amount of risk while a value of “six” would represent considerable risk.

This step 102 will accommodate assessing and metricizing risk using any desired approach. For example, if desired, this assessment can be based upon a corresponding characterization of various present configurations of the platform itself that can individually or in combination present, or mitigate, risk to the user's sensitive transaction. Examples of such configurations include, but are not limited to:

Whether the platform is presently wirelessly coupled (via, for example, Wi-Fi, Bluetooth, or the like) to another party or network unrelated to the sensitive transaction itself.

Whether the platform is presently otherwise coupled (via, for example, a Universal Serial Bus (USB) connection, an Ethernet connection, and so forth) to another party or network unrelated to the sensitive transaction itself.

The secure or unsecure nature of any existing external network connections.

How recently the platform's software has been checked for malware of various kinds or operational integrity.

A presence of unauthenticated software presently executing on the platform.

Presently-detected anomalous network behavior.

This assessment of risk can also, in lieu of the above or in combination therewith, be based upon a relative view of the sensitivity of the transaction itself. For example, a sensitive transaction that likely (or assuredly) involves the use of a PIN for an on-line non-financial account might be viewed as presenting a relatively lesser risk of potential harm to the user than a sensitive transaction that likely (or assuredly) involves the use of the user's Social Security number.

Presuming the determination of a relative-risk value as per the above, this process 100 will also accommodate, if desired, the optional step 103 of determining whether the relative-risk value compares unfavorably to a required level of security. By one approach, this required level of security can be set by the end user or by some other party (such as a system, network, or platform administrator). These teachings will also accommodate, if desired, automatically setting this required level of security via a local or remote capability. As an example of comparing this relative-risk value with a required level of security, and continuing with the example presented above, a relative value of “three” may be required for a particular sensitive transaction. In such a case, when a comparison of the presently determined value to the required value reveals that the presently determined value exceeds “three,” the relative-risk value compares unfavorably to the required level of security.

When this occurs, this process 100 will accommodate taking some corresponding action. For example, as illustrated, this can comprise the optional step 104 of inhibiting part, or all, of the sensitive transaction. Such an automated response can be accompanied, if desired, by corresponding alerts to the user. Such alerts can comprise audible alerts, visual alerts, and so forth. Other possibilities exist in these regards. By way of illustration, the process 100 may permit the sensitive transaction to continue but may provide an automated notice or alert to some third party such as the user's supervisor, spouse, parent, or other relevant authority figure.

In any event, in response to having detected that the user is preparing to use the transaction-enablement platform to facilitate a sensitive transaction, this process 100 provides the step 105 of pre-enabling transaction-enablement platform functionality as pertains to the sensitive transaction. When the transaction-enablement platform comprises, at least in part, an automatically modifiable user-input interface, this can comprise, for example, modifying the user-input interface to display information regarding at least one item of transaction-enablement platform functionality.

To illustrate, this can comprise displaying information comprising at least one user-selectable functional option. As another illustration in these regards, this can comprise displaying information regarding transaction-enablement platform functionality that is frequently (though not necessarily always) used when facilitating the sensitive transaction.

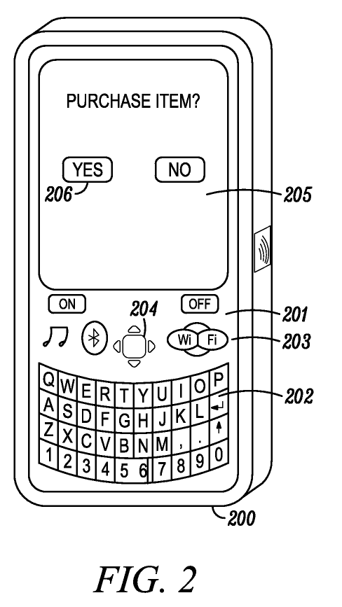

To illustrate by way of example (but without intending any limitations in these regards), and referring momentarily to FIG. 2, a given transaction-enablement platform 200 can have a front panel 201 comprising a touch-screen display. During an ordinary mode of operation, this transaction-enablement platform 200 displays a QWERTY keyboard 202, some state/status indicators/selectors 203, a cursor controller 204, and a general display area 205. Such elements are suitable to support various “ordinary” activities such as writing and storing a memo within the platform 200, listening to locally-stored music or watching a locally-stored video, and so forth.

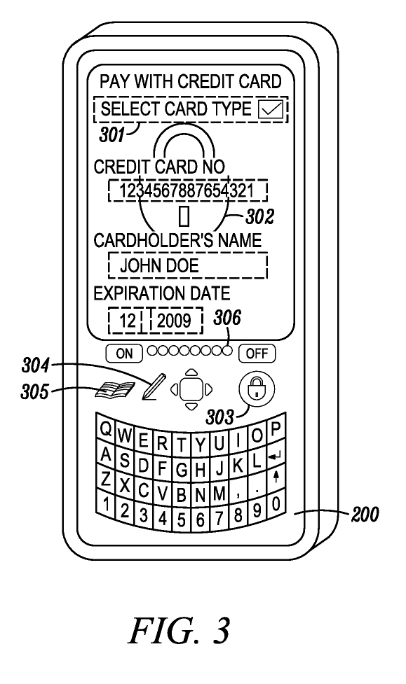

Per the described process, upon detecting that the user is preparing to facilitate a sensitive transaction (for example, by clicking on the “yes” button 206 in response to the query “purchase item?”), the step 105 of pre-enabling transaction-enablement platform functionality as pertains to the sensitive transaction can include altering the front panel 201. To illustrate, and referring now to FIG. 3, this can comprise automatically recalling from memory certain payment information 301 as pertains to this user. For example, this can comprise recalling the user's name, credit card number, and credit card expiration date.

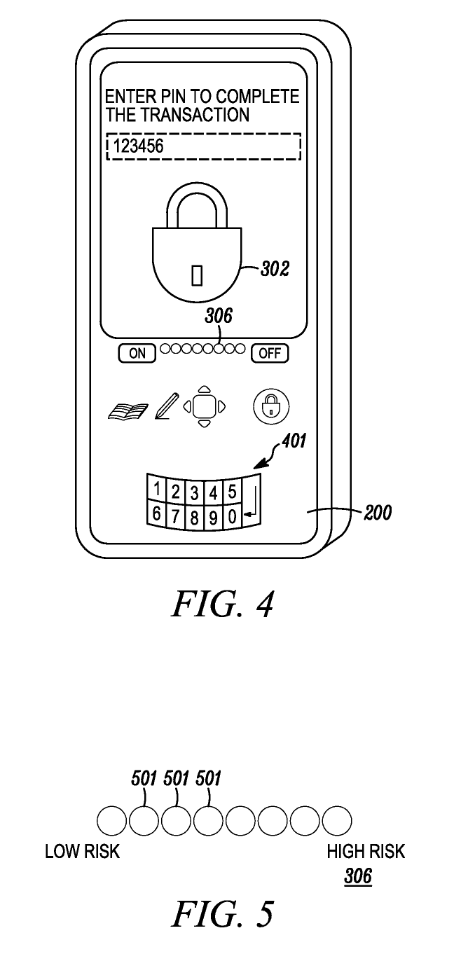

Referring now momentarily to FIG. 4, and as another illustrative example in these regards, when the sensitive transaction is characterized by entering the user's PIN for a given account or other corresponding service or purpose this step can comprise automatically providing a keyboard 401 that is uniquely simplified yet appropriate to enter such information. Here, for example, where the PIN comprises a four-digit number, the keyboard 401 (which can comprise, for example, a soft keyboard on a touch-screen display) comprises only the integers from zero to nine plus an “enter” key. Such an approach can simply the PIN-entry task by eliminating keys that can only be used in error. This also permits the remaining keys to be larger if desired and therefore easier to locate and select.

Referring again to FIG. 1, this process 100 also provides for the step 106 of automatically limiting transaction-enablement platform functionality that does not support the sensitive transaction and that poses a risk to the sensitive transaction (for example, a computational-integrity risk or the like might not necessarily present the risk of comprising sensitive information through unwanted public exposure of that information). This can comprise limiting in some incomplete sense or this can comprise, for example, suspending the operability of this transaction-enablement platform functionality to thereby wholly abate this source of risk. To illustrate, this can comprise suspending the operability of an external interface (such as, but not limited to, a Bluetooth interface, a Wi-Fi interface, or a wired local area network interface, to note but a few examples in these regards). As another example in these regards, this can comprise halting an application having known vulnerabilities or that has not been appropriately authenticated.

As another illustrative example in these regards, this can comprise suspending the operability of an application that is not necessary to facilitating the sensitive transaction. As one very simple example in these regards, this might comprise suspending a music-rendering application to thereby halt the playing of music or a game that might otherwise distract the user from paying keen attention to the sensitive transaction. As another example, this might comprise blocking an incoming or outgoing cellphone call (while possibly nevertheless permitting certain calls, such as 911 calls upon securely terminating the ongoing sensitive transaction).

So configured, a transaction-enablement platform can automatically modify itself to better support the sensitive transaction while also actively reducing security risks that correspond to that sensitive transaction. These steps can be the automatic result of determining that the user is preparing to engage in this sensitive transaction. These benefits therefore accrue in a manner that is not dependent upon knowing or intentional behaviors on the part of the user to achieve such benefits.

With continued reference to FIG. 1, this process 100 will also accommodate the optional step 107 of automatically significantly altering an appearance of an end-user interface as comprises a part of the transaction-enablement platform to thereby alert the user that the user is facilitating a sensitive transaction. As already illustrated above with FIGS. 2 and 3, this can comprise, in whole or in part, presenting information dedicated to facilitating the sensitive transaction in a highly-perceptible form (i.e., in a form that is more likely than not to attract the cognitive attention of the user within a short period of time of becoming available). This might comprise, as one example, presenting sensitive information such as that displayed in FIG. 3 using some color (such as a bright red font) that is not typically used to present other informational content.

As another illustrative example, this might comprise employing a display background that uniquely signifies facilitating a sensitive transaction. In this illustrative example, a watermark icon 302 in the form of a locked padlock serves in this regard. By only displaying this watermark icon 302 when in this state of operability, the user receives a distinctive and cognitively obvious indication that the transaction-enablement platform is presently facilitating a sensitive transaction. The size, central prominence, and uniqueness of this watermark icon 302 aid in ensuring that this device is highly perceivable to the user.

These teachings will readily accommodate other approaches in these same regards. For example, an illuminated button comprising a secure-mode indicator 303 can be uniquely provided in substitution for a non-secure-mode indicator to signify when facilitating a sensitive transaction. Another user-selectable soft button 304 could serve, for example, to permit the user to toggle a highlighting effect for protected content in the informational display 301 (or to toggle between displaying protected content in a readable form and occluding this content or representing this content with a series of uniform characters such as asterisks). Yet another user-selectable soft button 305 can permit the user to store certain selected content as secure information in the memory of the platform or to permit the user to recall secure information from the platform's memory. These teachings are well compatible with any number of other possibilities in these regards as well.

As noted earlier, this process 100 can optionally accommodate determining a relative-risk metric as pertains to facilitating a sensitive transaction using the transaction-enablement platform in a present operating state. This relative-risk value can be displayed if desired as a particular value within a displayed range of risk-metric values as shown in FIGS. 3 and 4 via reference numeral 306. There are any number of ways by which such a display can be provided. As perhaps better shown in FIG. 5, this display 306 can comprise a line of circles 501. The relative level of risk can be indicated by illuminating these circles 501 in gauge-like fashion. Illuminating only two such circles 501 (from the left), for example, will indicate relatively low risk while illuminating seven such circles (again from the left) will indicate relatively high risk. Those skilled in the art will recognize that any number of other display form factors can be employed to similar effect.

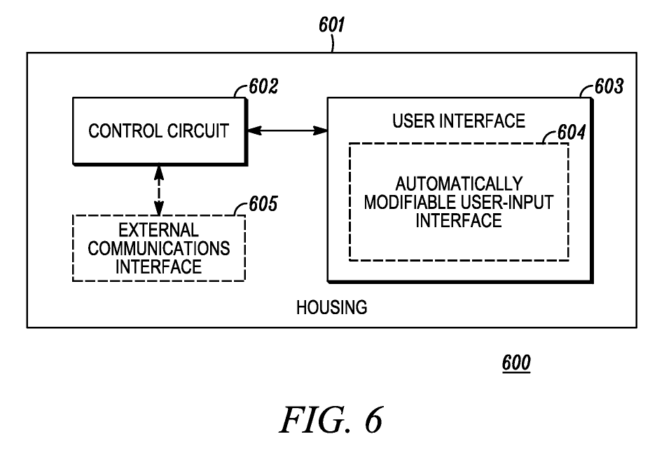

Those skilled in the art will appreciate that the above-described processes are readily enabled using any of a wide variety of available or readily configured platforms, including partially or wholly programmable platforms as are known in the art or dedicated purpose platforms as may be desired for some applications. Referring now to FIG. 6, an illustrative approach to such a platform will now be provided.

This transaction-enablement platform 600 includes a housing 601 that contains a control circuit 602 and that supports a user interface 603 of choice. Those skilled in the art will recognize and appreciate that such a control circuit 602 can comprise a fixed-purpose hard-wired platform or can comprise a partially or wholly programmable platform. All of these architectural options are well known and understood in the art and require no further description here. This control circuit 602 operably couples to the user interface 603 and receives user input from there and provides information for the user thereto.

This user interface 603 can comprise, if desired, in whole or in part, an automatically modifiable user-input interface 604. Examples in this regard include, but are not limited to, active displays, touchscreen displays, soft buttons, and so forth.

This transaction-enablement platform 600 can also comprise, if desired, an external communications interface 605 that is also supported by the housing 601 and that also operably couples to the control circuit 602. This can comprise a wireless or a non-wireless interface as desired. It will be understood that this external communications interface 605 can comprise a plurality of discrete interfaces that compatibly support a corresponding variety of different communications mediums and protocols. Such components and practices are well known in the art and require no further elaboration here.

The control circuit 602 can be configured (using, for example, corresponding programming as will be well understood by those skilled in the art) to carry out one or more of the steps, actions, or functions described herein. This can comprise, for example, configuring the control circuit 602 to detect when a user of the transaction-enablement platform 600 is preparing to use the transaction-enablement platform 600 to facilitate a sensitive transaction and then responsively pre-enabling transaction-enablement platform functionality as pertains to the sensitive transaction and also limiting transaction-enablement platform functionality that does not support the sensitive transaction and that also poses a risk to the sensitive transaction.

Those skilled in the art will recognize and understand that such an apparatus 600 may be comprised of a plurality of physically distinct elements as is suggested by the illustration shown in FIG. 6. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, a given user's sensitive information can be protected without requiring that the user be highly trained with respect to such matters. These teachings are well suited for use in multi-purpose platforms and systems where a vibrant mix of non-sensitive transactions and transactions having a wide range of sensitivity are to be expected. Accordingly, those skilled in the art will appreciate the ease by which these teachings can be leveraged using many presently-known platforms and approaches.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A portable transaction-enablement platform comprising:
a housing;
a user interface supported by the housing; and
a control circuit disposed within the housing and operably coupled to the user interface and configured to:
detect when the user is preparing to use the transaction-enablement platform to facilitate a sensitive transaction; and
in response to detecting that the user is preparing to use the transaction-enablement platform to facilitate a sensitive transaction, automatically:
pre-enabling transaction-enablement platform functionality as pertains to the sensitive transaction; and
limiting transaction-enablement platform functionality that does not support the sensitive transaction and that poses a risk to the sensitive transaction.

2. The transaction-enablement platform of claim 1 further comprising an external communications interface that is supported by the housing and that operably couples to the control circuit.

3. The transaction-enablement platform of claim 1 wherein:
the user interface comprises, at least in part, an automatically modifiable user-input interface; and
pre-enabling transaction-enablement platform functionality as pertains to the sensitive transaction comprises, at least in part, modifying the user-input interface to display information regarding at least one item of transaction-enablement platform functionality.

4. The transaction-enablement platform of claim 3 wherein the information comprises at least one user-selectable functional option.

5. The transaction-enablement platform of claim 3 wherein modifying the user-input interface to display information regarding at least one item of transaction-enablement platform functionality comprises, at least in part, modifying the user-input interface to display information regarding at least one item of transaction-enablement platform functionality that is frequently used when facilitating the sensitive transaction.

6. The transaction-enablement platform of claim 1 wherein limiting transaction-enablement platform functionality that does not support the sensitive transaction and that poses a risk to the sensitive transaction comprises, at least in part, suspending operability of at least one transaction-enablement platform functionality that does not support the sensitive transaction and that poses a risk to the sensitive transaction.

7. The transaction-enablement platform of claim 6 wherein suspending operability of at least one transaction-enablement platform functionality that does not support the sensitive transaction and that poses a risk to the sensitive transaction comprises, at least in part, suspending operability of an external interface.

8. The transaction-enablement platform of claim 6 wherein suspending operability of at least one transaction-enablement platform functionality that does not support the sensitive transaction and that poses a risk to the sensitive transaction comprises, at least in part, suspending operability of an application that is not necessary to facilitating the sensitive transaction.

9. A method for use with a portable transaction-enablement platform, the method comprising:
at the transaction-enablement platform:
detecting when a user of the transaction-enablement platform is preparing to use the transaction-enablement platform to facilitate a sensitive transaction; and
in response to detecting that the user is preparing to use the transaction-enablement platform to facilitate a sensitive transaction, automatically:
pre-enabling transaction-enablement platform functionality as pertains to the sensitive transaction; and
limiting transaction-enablement platform functionality that does not support the sensitive transaction and that poses a risk to the sensitive transaction.

10. The method of claim 9 further comprising:
in response to detecting that the user is preparing to use the transaction-enablement platform to facilitate a sensitive transaction, automatically significantly altering an appearance of an end-user interface as comprises a part of the transaction-enablement platform to thereby alert the user that the user is facilitating a sensitive transaction.

11. The method of claim 10 wherein significantly altering an appearance of an end-user interface as comprises a part of the transaction-enablement platform to thereby alert the user that the user is facilitating a sensitive transaction comprises, at least in part, modifying the end-user interface such that the end-user interface now presents information dedicated to facilitating a sensitive transaction in a highly-perceptible form.

12. The method of claim 11 wherein the information dedicated to facilitating a sensitive transaction comprises a display background that uniquely signifies facilitating a sensitive transaction.

13. The method of claim 11 wherein the information dedicated to facilitating a sensitive transaction comprises an illuminated button that uniquely signifies facilitating a sensitive transaction.

14. The method of claim 9 wherein pre-enabling transaction-enablement platform functionality as pertains to the sensitive transaction comprises, at least in part, displaying a relative-risk indication.

15. The method of claim 14 wherein displaying a relative-risk indication comprises displaying a relative-risk indication that presents a present risk-metric value within a displayed range of risk-metric values.

16. The method of claim 15 wherein displaying a relative-risk indication that presents a present risk-metric value within a displayed range of risk-metric values comprises calculating the present risk-metric value as a function of a plurality of differing risk-evaluation considerations.

17. The method of claim 9 further comprising:
determining a relative-risk value as pertains to the sensitive transaction;
when the relative-risk value compares unfavorably to a required level of security, inhibiting the sensitive transaction.
